(19) United States
(12) Patent Application Publication
(10) Pub. No.: US 2012/0071022 A1
(43) Pub. Date: Mar. 22, 2012

(54) LOWER PROFILE CABLE ASSEMBLY WITH A METAL SHELL FOR PREVENTING EMI

(75) Inventors: PING-SHENG SU, New Taipei (TW); XIAO-LI LI, Kunshan (CN)

(73) Assignee: HON HAI PRECISION INDUSTRY CO., LTD., New Taipei (TW)

(21) Appl. No.: 13/237,986

(22) Filed: Sep. 21, 2011

(30) Foreign Application Priority Data
Sep. 21, 2010 (CN) 201020538583.0

(51) Int. Cl. H01R 13/648; H01R 13/58

(52) U.S. Cl. 439/449; 439/607.01

(57) ABSTRACT

A cable assembly comprises an insulative housing, a plurality of first conductive terminals enclosed in the insulative housing, a plurality of second conductive terminals enclosed in the insulative housing, a cable having a number of wire and electrically connecting the first and second conductive terminals and a metal shell assembled on the outer surface of the insulative housing. Each of the first conductive terminals having a straight first contacting portion, and each of the second conductive terminals having a bending second contacting portion. The insulative housing has a main portion enclosed in the metal shell and an exposing portion extending forwardly from the main portion and exposed out of the front end of the metal shell. The first conductive terminals are partly exposed out of the front end of the metal shell.

### FIELD OF THE INVENTION

The present invention relates to a cable assembly, and more particularly to a cable assembly having a metal shell for preventing EMI (Electromagnetic Interference).

### DESCRIPTION OF PRIOR ART

Universal Serial Bus (USB) is a serial bus standard to the PC architecture with a focus on computer telephony interface, consumer and productivity applications. The interface design of USB is standardized by the USB Implementers Forum (USB-IF), an industry standardized organization founded by computer and communication companies. And USB cables used to connect peripherals such as mouse devices, keyboards, PDAs, gamepads and joysticks, scanners, digital cameras, printers, external storage, networking components, etc. For many devices such as scanners and digital cameras, USB has become the standard connection method.

Nowadays, It is popular to use to connect peripherals by USB 2.0 devices, USB 2.0 devices are capable of operating at 480 Mbps. However, as technology progresses engineers are constantly striving to increase operating speeds, as a consequence, faster serial-bus interfaces are being introduced to address different requirements. USB 3.0 was born.

Taiwan Pat. NO. M357095, issued on May 11, 2009, disclosed a cable assembly 3.0 interface. A metal shell is formed on the cable assembly, of which an upper and lower surface having a connecting holes fastened a mating connector. However, some components among the connecting holes and a front end of the metal shell could be left unused, so as to waste a lot of material and space.

As discussed above, an improved cable assembly overcoming the shortages of existing technology is needed.

### SUMMARY OF THE INVENTION

Accordingly, an object of the present invention is to provide a lower profile cable assembly.

In order to achieve the above-mentioned objects, a cable assembly, comprising: an insulative housing, a plurality of first conductive terminals enclosed in the insulative housing, a plurality of second conductive terminals enclosed in the insulative housing, a cable having a number of wire and electrically connecting the first and second conductive terminals and a metal shell assembled on the outer surface of the insulative housing. Each of the first conductive terminals having a straight first contacting portion, and each of the second conductive terminals having a bending second contacting portion. The insulative housing has a main portion enclosed in the metal shell and an exposing portion extending forwardly from the main portion and exposed out of the front end of the metal shell. The first conductive terminals are partly exposed out of the front end of the metal shell.

Other objects, features and advantages of the invention will be apparent from the following detailed description taken in connection with the accompanying drawings.

### BRIEF DESCRIPTION OF THE DRAWINGS

FIG. 1 is a perspective view of a cable assembly in accordance with the present invention;

FIG. 2 is an exploded, perspective view of the cable assembly shown in FIG. 1;

FIG. 3 is a view similar to FIG. 2, from another aspect;

FIG. 4 is a cross section view of the cable assembly of FIG. 1 taken along line 4-4; and

FIG. 5 is another cross section view of the cable assembly of FIG. 1 taken along line 5-5.

### DETAILED DESCRIPTION OF PREFERRED EMBODIMENTS

Reference will now be made to the drawing figures to describe the present invention in detail.

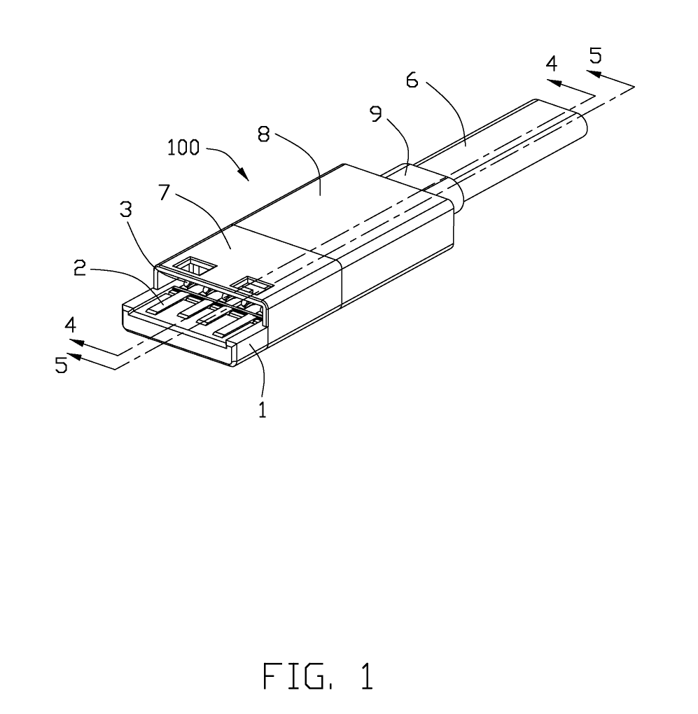

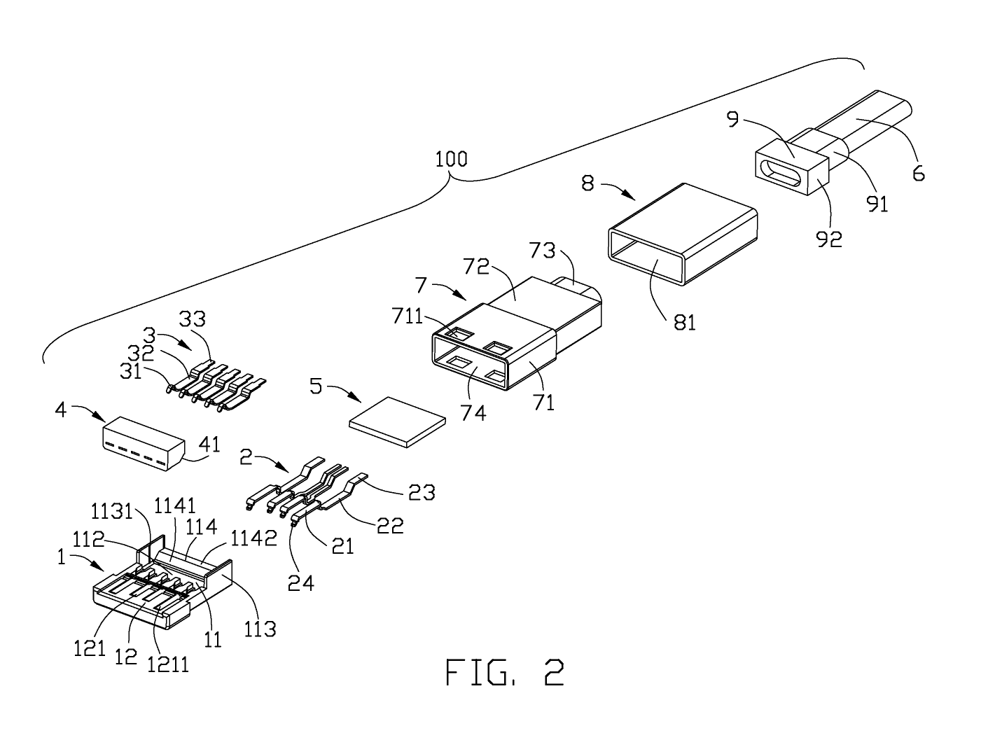

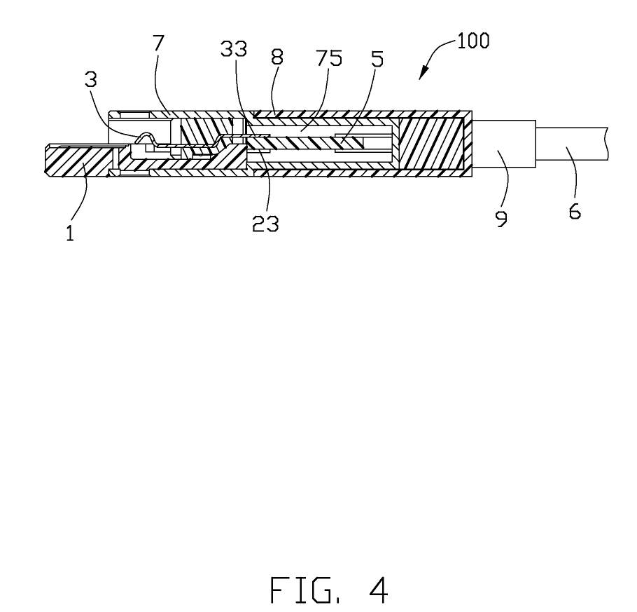

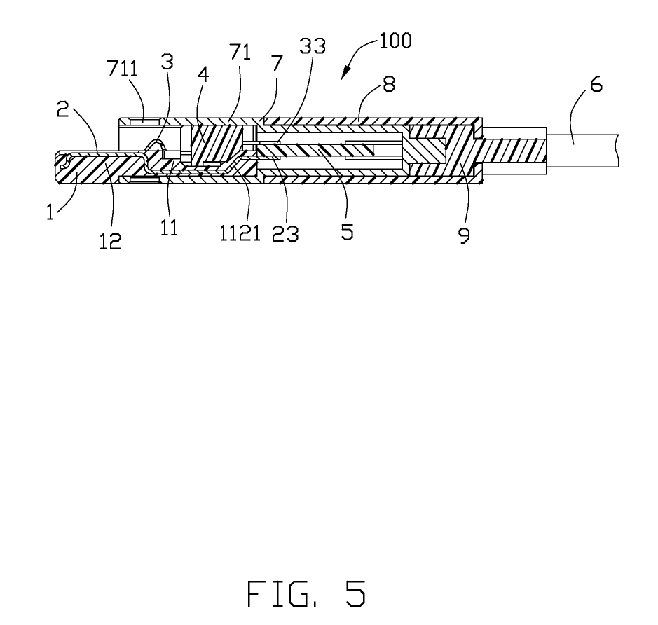

Referring to FIGS. 1 to 5, a cable assembly 100 in accordance with the present invention comprises a plurality of first conductive terminals 2, an insulative housing 1 molding on the first conductive terminals 2, a mounting bar 4 installed in the insulative housing 1, a plurality of second conductive terminals 3 enclosed in the mounting bar 4, a PCB (printed circuit board) 5 located behind the insulative housing 1, a cable 6 having a wire(not shown) and soldered on the PCB 5, a metal shell 7 enclosing the insulative housing 1 and the PCB 5 and a rear cover 8 installed on the rear of the metal shell 7.

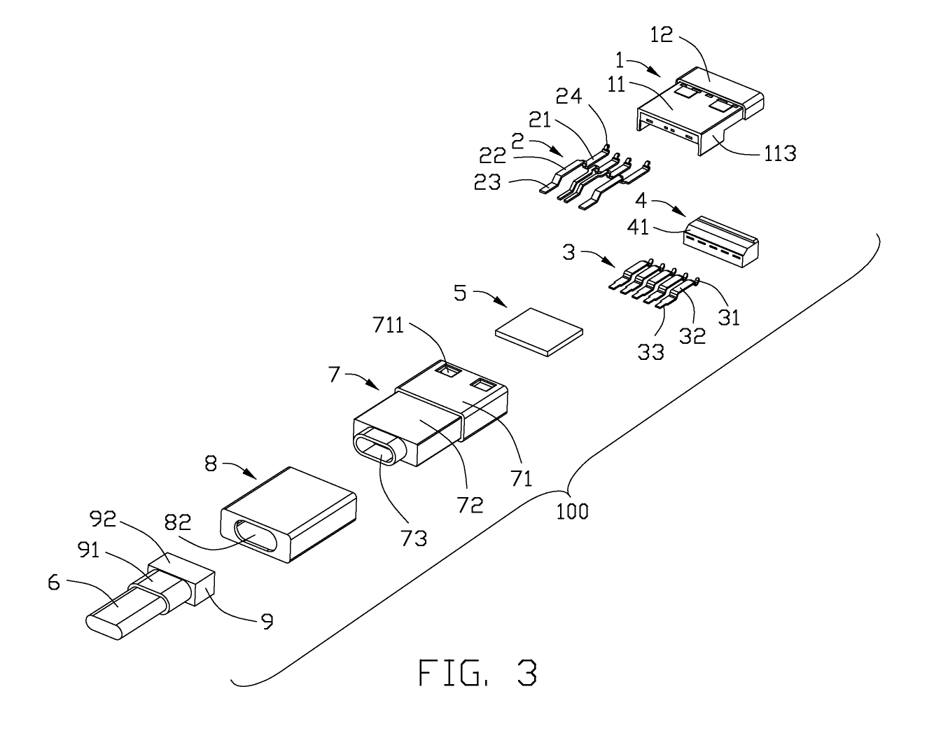

The insulative housing 1 comprises a main portion 11 and an exposing portion 12 extending forwardly from the main portion 10 wherein a front section of the main portion 11 and the exposing portion 12 commonly define a mating portion. The main portion 11 has a lower wall 112, two lateral walls 113 respectively extending upwardly from two sides of the lower wall 112 and a trapeziform convex 114 extending upwardly from a rear section of the lower wall 112 and located between two lateral walls 113. A notch 1121 is recessed forwardly from a rear surface of the lower wall 112 and receiving the first conductive terminals 2. A pair of ribs 1131 are respectively raised inwardly from the inner surface of two lateral walls 113 and connected to the lower wall 112. The convex 114 has an upper surface 1142 and a slanting surface 1141 connecting the lower wall 112 with the upper surface 1142. The convex 114 is located between the ribs 1131. The exposing portion 12 has a lower wall 121 and two lateral walls 122 respectively extending upwardly from both sides of the lower wall 121. A number of passageways 1211 is recessed downwardly from an inner surface of the lower wall 121 and communicated with the notch 1121. Referring to FIG. 3, an outer surface of the lower wall 121 of the exposing portion 12 is overstepped an outer surface of the lower wall 112 of the main portion 11.

Each of the first conductive terminals 2 comprises a first retaining portion 22, a straight first contacting portion 21 extending forwardly from the first retaining portion 22, a first soldering portion 23 located behind the first retaining portion 22 and an ending portion 24 located on the front of the first contacting portion 21. Each of the second conductive terminals 3 comprises a second retaining portion 32, a second contacting portion 31 extending forwardly from the second retaining portion 32 and a second soldering portion 33 located behind the second retaining portion 32. The second contacting portion 31 is bending and flexible.

The mounting bar 4 is trapeziform and has a slanting surface 41.

The metal shell 7 is made of zinc alloy die-casting and comprises a front shell 71 located on the front thereof and enclosing the main portion 11 of the insulative housing 1, a rear shell 72 extending rearwardlly from the from shell 71 and a ring 73 located behind the rear shell 72. A first receiving space 74 and a second receiving space 75 recessed from the front surface of the metal shell 7 is respectively surrounded by the front shell 71 and the rear shell 72. The second receiving space 75 is communicated with the ring 73. Two pairs of mating holes 711 define on the upper and lower surface of the front shell 71.

The rear cover 8 is made from metal material, and in other embodiment, the rear cover 8 also can be made from plastic or other insulative material. The rear cover 8 has a recessing space 81 recessing rearwardly from the front surface thereof and a through hole 82 penetrating the rear wall thereof

The cable assembly 100 also includes a strain relief portion 9 molding on the cable 6 and comprises a first portion 91 enclosing the cable 6 and a rectangular second portion 92 located on the front end of the first portion 91.

In assembly, the insulative housing 1 is molded on the first conductive terminals 2, the first retaining portions 22 of the conductive terminals 2 are received in the notch 1121, the contacting portions 21 of the conductive terminals 2 are received in the passageways 1211, the upper surface of the contacting portions 21 are exposed on the lower wall 121 of the exposing portion 12, the ending portion 24 of the conductive terminals 2 are received in the lower wall 121, and the soldering portion 23 of the conductive terminals are beyond the rear surface of the insulative housing 1. The second conductive terminals 3 are molded in the mounting bar 4, the mounting bar 4 encloses the second retaining portions 32 of the conductive terminals 3, the second contacting portions 31 are beyond the mounting bar 4, and the second soldering portions 33 of the conductive terminals 3 are located behind the mounting bar 4.

The mounting bar 4 is assembled in the insulative housing 1 and is held between the ribs 1131 of the lateral walls 113 of the main portion 11. The slanting surface 41 of the mounting bar 4 is attached to the slanting surface 1141 of the convex 114. The lower surface of the mounting bar 4 is located on the lower wall 112 of the main portion 11. Two sides of the mounting bar 4 are attached to the inner surface of the lateral walls 113 of the main portion 11. The second conductive terminals 3 are located above the first conductive terminals 2. Looking down from above, the first and second conductive terminals 2, 3 are intervals.

The first soldering portion 23 and the second soldering portion 33 are respective soldered on front end of the upper and lower surface of the PCB 5. the wires of the cable 6 are soldered on another end.

The metal shell 7 is assembled on the insulative housing 1 from rear to front direction. The front surface of the metal shell 7 is attached to the rear surface of the exposing portion 12, and the exposing portion 12 is exposed on the front end of the metal shell 7. The main portion 11 of the insulative housing 1 is receiving in the first receiving space 74. The first contacting portions 21 of the first conductive terminals 2 are partly exposed on the front end of the metal shell 7. In the other embodiment, the first contacting portions 21 can completely expose on the front end of the metal shell 7. The second contacting portions 31 of the second conductive terminals 3 are not beyond the front end of the metal shell 7. The lateral walls and the lower wall of the front shell 71 of the metal shell 7 are respectively aligned to the lateral walls and the lower wall of the exposing portion 12. The rear surface of the main portion 11 is attached to the rear inner surface of the front shell 71.

The strain relief portion 9 is molded on the cable 6. The second portion 92 encloses the ring 73 of the metal shell 7 and the first portion 91 encloses the cable 6.

The rear cover 8 is assembled on the metal shell 7, and the recessing space 81 of the rear cover 8 encloses the rear shell 72 of the metal shell 7. Both are interference. The front surface of the rear cover 8 is attached to the rear surface of the front shell 71. The recessing space 81 also encloses the second portion 92 and the outer surface of the rear cover 8 is aligned to the outer surface of the front shell 71.

It will be understood that the invention may be embodied in other specific forms without departing from the spirit or central characteristics thereof The present examples and embodiments, therefore, are to be considered in all respects as illustrative and not restrictive, and the invention is not to be limited to the details given herein.

What is claimed is:

1. A cable assembly, comprising:
an insulative housing;
a plurality of first conductive terminals enclosed in the insulative housing, each of the first conductive terminals having a straight first contacting portion;
a plurality of second conductive terminals enclosed in the insulative housing, each of the second conductive terminals having a bending second contacting portion,
a cable having a number of wires and electrically connected to the first and second conductive terminals; and
a metal shell assembled on the outer surface of the insulative housing,
wherein the insulative housing has a main portion enclosed in the metal shell and an exposing portion extending forwardly from the main portion and exposed out of the front end of the metal shell,
wherein the first conductive terminals are partly exposed out of the front end of the metal shell.

2. The cable assembly as recited in claim 1, wherein the contacting portions of the first conductive terminals are completely exposed out of the front end of the metal shell.

3. The cable assembly as recited in claim 1, wherein the front surface of the metal shell is attached to the exposing portion of the insulative housing.

4. The cable assembly as recited in claim 1, wherein the second contacting portions of the second conductive terminals are enclosed in the metal shell.

5. The cable assembly as recited in claim 1, wherein the cable assembly also comprises a mounting bar assembled in the insulative housing and enclosing the second conductive terminals.

6. The cable assembly is recited in claim 1, wherein two lateral walls and a lower wall of the metal shell is respectively aligned to the two lateral walls and a lower wall of the exposing portion.

7. The cable assembly is recited in claim 6, wherein the metal shell comprises a front shell located on the front thereof, a rear shell extending rearwardly from the front shell and a ring extending rearwardly from the rear shell.

8. The cable assembly is recited in claim 7, wherein the cable assembly also comprises a rear cover enclosing the rear shell, the outer surface of the rear cover is aligned to the outer surface of the front shell.

9. The cable assembly is recited in claim 8, wherein the cable assembly also comprises a strain relief portion enclosing the ring and the cable, and the strain relief portion is partly received in the rear cover.

10. The cable assembly is recited in claim 1, wherein the metal shell is made of zinc alloy die-casting.

11. A cable assembly, comprising:
an insulative housing enclosed in a metal shell and having an exposing portion exposing on the front of the metal shell;
a plurality of conductive terminals located in the insulative housing; and
a cable having a number of wires and electrically connecting to the conductive terminals;
wherein an opening is surrounded by an upper surface of the exposing portion and a front surface of the metal shell, and some of the conductive terminals are partly exposed in the opening

12. The cable assembly is recited in claim 11, wherein the conductive terminals includes a plurality of first conductive terminals and a plurality of second conductive terminals.

13. The cable assembly is recited in claim 12, wherein each of the first conductive terminals has a straight first contacting portion and each of the second conductive terminals has a bending second contacting portion.

14. The cable assembly is recited in claim 13, wherein the first contacting portions are partly exposed in the opening

15. The cable assembly is recited in claim 14, wherein the second contacting portions are enclosed in the metal shell.

16. A cable connector assembly comprising:
an insulative housing unit defining a mating portion defining front and rear sections thereof in a front-to-back direction;
a plurality of first contacts disposed in the housing and defining first contacting sections exposed upon the front section of the mating portion;
a plurality of second contacts disposed in the housing and defining second contacting sections exposed upon the rear section of the mating portion;
a metallic shell enclosing the rear section of the mating portion but exposing the front section of the mating portion including the corresponding first contacting sections thereon to an exterior in a vertical direction perpendicular to said front-to-back direction.

17. The cable connector assembly as claimed in claim 16, wherein each of the first contacting sections is partially exposed to the exterior in the vertical direction.

18. The cable connector assembly as claimed in claim 16, wherein the front section of the mating portion is fully exposed to the exterior circumferentially.

19. The cable connector assembly as claimed in claim 18, the section of the mating portion defines a step structure to receive a front end region of the shell therein so as to essentially result in a coplanar manner with the shell for compliant receipt within a receptacle connector.

20. The cable connector assemble as claimed in claim 16, wherein the first contacts are integrally assembled by the housing unit while the second contacts are integrally assembled by a mounting bar which is positioned upon the housing unit.
